(19) United States
(12) Patent Application Publication
(10) Pub. No.: US 2006/0293082 A1
(43) Pub. Date: Dec. 28, 2006

(54) Extension of the sim card in gsm devices

(76) Inventor: Hans Jurgen Neuhaus, Berlin (DE)

Correspondence Address: BELL, BOYD & LLOYD, LLC, P. O. BOX 1135, CHICAGO, IL, 60690-1135, US

(21) Appl. No.: 10/571,502

(22) PCT Filed: Sep. 10, 2003
(86) PCT No.: PCT/DE03/03046

§ 371 Date: Mar. 10, 2006

(51) Int. Cl. H04B 1/38

(52) U.S. Cl. 455/558

(57) ABSTRACT

Circuit arrangement as an interface between a SIM card and a GSM modem, which has a bidirectional data line that connects a card data input/output of the SIM card to a modem data input/output of the GSM modem, with the data line being coupled to at least one edge driver.

### FIELD OF TECHNOLOGY

The present disclosure relates to a circuit arrangement and to a method for bidirectional data transmission.

### BACKGROUND

SIM cards have become established as the standard for authentication of a user of a GSM mobile radio. In conventional GSM appliances, such as a mobile telephone, the card reader for SIM cards is integrated in the appliance. As the functionality of GSM appliances increases, the importance of the SIM card is also growing, however, and the SIM card is no longer used just to check the authorization to make telephone calls, but for different applications, such as access authorization to secure areas, that is to say in the end as a key substitute, or for payment functions.

In this case, it has been found that, for some applications, physical separation between the SIM card reader and the GSM appliance is desirable. For example, the SIM card may be inserted in a corresponding card reader in a motor vehicle, in order to authenticate the user of a GSM system in the vehicle in this way. Furthermore, both in the private field and in the commercial field, a user may be authenticated by means of a SIM card reader for telephone systems, computers, network parts, automatic payment machines or other appliances with GSM functionality. In this case, for security reasons, a direct link may be provided between the card reader and the GSM appliance for the transmission of the authentication data and, in the applications which have been mentioned, this must often have a length of several meters, owing to the physical characteristics.

Generally, however, the electrical drivers for the SIN card interface in GSM modems are designed only for distances of less than 50 cm.

Various currently marketed integrated circuits allow this to be extended to several meters. However, since the data line to the SIM card is designed to be bidirectional, these circuits require a control signal for the signal direction. However, no such signal is externally available on standard GSM modems.

Some of the abovementioned circuits are thus designed only for direct integration in GSM modems, which has the disadvantage that, as a result of the modern manufacturing methods, each of the GSM modems that is produced in a range must be equipped with a circuit such as this, irrespective of whether or not this is desired. A further disadvantage of these circuits is that they are costly.

It is also possible to arrange a circuit arrangement for direction evaluation of the data line outside the GSM modem, and thus to control data line drivers which may comprise an integrated circuit or other electronic components. However, a circuit arrangement such as this has a number of disadvantages. In addition to the fact that its implementation involves a high degree of complexity, the use of simple line drivers results in the problem of the entire SIM interface being switched to an inactive, high-impedance state. Furthermore, a circuit apparatus such as this with a signal direction evaluator requires additional cable wires, which involves additional complexity in manufacturing, and thus increased production costs.

Another possibility is to use GSM modems with a remote access function for SIM data (so-called remote SIM access or RSA). In this case, the data is written to and read from the SIM card at a remote point, and is interchanged between the GSM modem and the SIM card by means of AT commands (Hayes standard command set for modems, from ATtention). The data is in this case transmitted via wire or radio (for example Bluetooth). This solution is likewise costly and is dependent, moreover, on the use of GSM modems with RSA functionality, which are available only in limited numbers on the market.

### SUMMARY

An apparatus and method is disclosed to provide the capability to connect a separate SIM card reader to a standard GSM modem which has neither an external signal for the data signal direction nor RSA functionality. At the same time, the intention is thus to create the basis for the capability to advantageously lengthen the connecting path to several meters.

Under an exemplary embodiment, the data line between the two appliances to be connected, that is to say the GSM modem and the SIM card reader, is coupled to at least one edge driver. The edge driver is in this case used as a driver for the bidirectional data line and amplifies a corresponding edge of the signal, in order in this way to counteract effects which result from the capacitance of the connecting line and lead to flattening of the edge. The edge drivers assist the change in the charge in the capacitance of the extension line, and carry this out quickly. After the change in the charge in the capacitance, the edge drivers have no further effect, so that there is no further influence on static signals. Furthermore, the edge drivers allow the SIM interface to be lengthened without signal evaluation and without any signal direction signal, with the functionality of the interface being restricted.

This dynamic response of the edge drivers means that there is no influence on the steady-state characteristics of the SIM interface. In some applications, by way of example, the hardware of the SIM interface must be run down (switched off) completely. This switching-off is carried out by the GSM modem. Since the edge drivers act dynamically, they do not impede this function, thus ensuring unrestricted operation of the interface.

Under the embodiment, the data line is coupled to at least one edge driver both at the modem end and at the card end. The edge drivers in this case act on the respective active end, that is to say on the end of the data line connected to the output as a driver for the extension line, and at the passive end, that is to say at the end of the data line which is connected to the input, as a signal regenerator.

In an alternate embodiment, positive and negative edge drivers are used. Positive edge drivers are intended for the positive edge of the signal, that is to say for a rising edge; negative edge drivers support negative edges in a corresponding manner. Simultaneous use of positive and negative edge drivers ensures optimum conditioning of the data signal.

In a further embodiment, only positive edge drivers are used. This circuit arrangement provides a simple and low-cost embodiment of the present invention, with the operational capability of this embodiment being restricted by the signal quality which the modem and the SIM card can produce and (still) process, and thus also or predominantly by the length of the extension line.

The edge driver(s) is preferably constructed from discrete components. In particular, this offers a low-cost solution to the object on which the invention is based. As an alternative to this, the edge driver(s) may also be in the form of an integrated circuit, which ensures that little space is required.

Under the embodiment, each edge driver may in each case be matched to different signal frequencies, in particular by the capacitance of a coupling capacitor which couples the edge driver to the data line. This allows a broad range of use with regard to the frequencies that are used.

In a further embodiment, a resistor which is connected downstream from the coupling capacitor ensures an improvement in the interference voltage separation. This improves the functional reliability of the circuit arrangement, and improves the quality of the data transmission.

The response threshold of the edge driver(s) may, in a further advantageous embodiment, be set or tuned in particular by the insertion of a resistor into the circuit, with tunability being achieved, for example, with the aid of a potentiometer or a switchable resistance network.

The circuit arrangement is preferably characterized by a capacitor which is used to improve the response to transient interference. This also improves the functional reliability of the circuit arrangement according to the invention.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 shows a schematic circuit diagram or block diagram of a GSM modem and of a SIM card with a holder, having two connecting lines according to an exemplary embodiment;

FIG. 2 shows the circuit diagram of a first embodiment of a positive edge driver;

FIG. 3 shows the circuit diagram of a first embodiment of a negative edge driver;

FIG. 4 shows the circuit diagram of a second embodiment of a positive edge driver; and

FIG. 5 shows the circuit diagram of a second embodiment of a negative edge driver.

### DETAILED DESCRIPTION

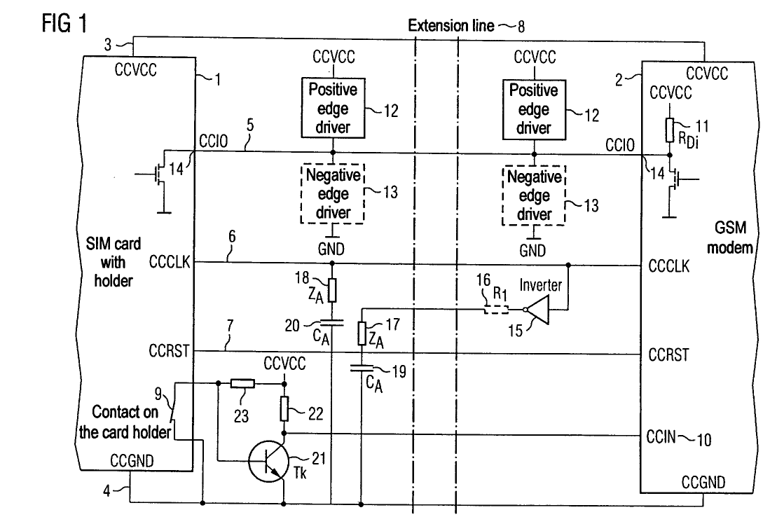

FIG. 1 shows a schematic illustration of a SIM card 1 with a holder, and a GSM modem 2. The SIM card 1 and the GSM modem 2 are connected to one another via the following lines: a CCVCC line 3, which provides the SIM card 1 with an operating voltage of 3 volts; a CCGND line 4, which provides the SIM card 1 with ground potential; a CCIO line 5, which is used as a bidirectional data line; a CCCLK line 6, which represents the clock line, with normal clock frequencies being approximately 1 MHz to approximately 4 MHz, and a CCRST line 7 as a reset line for the arrangement. The desired lengthening of the lines which connect the SIM card 1 to the GSM modem 2 is indicated by the extension line 8 which is illustrated in the center of the figure.

The SIM card holder additionally has a switching contact 9 which on the one hand monitors whether any SIM card 1 at all has been inserted into the card holder, and on the other hand evaluates whether the SIM card 1 is withdrawn from the SIM card holder during operation of the arrangement. In the present exemplary embodiment, the switching contact is designed as a leading contact, that is to say, by monitoring the level at a COIN input 10 while the SIM card is being withdrawn from the SIM card holder, the GSM modem has the capability to run down the entire SIM interface and to switch it to a high impedance even before the interface contacts are interrupted during the withdrawal of the SIM card from the SIM card holder.

The abovementioned lines and the respective lengthenings of the lines as well as the preconditions for the lengthening of the lines will be considered in more detail in the following text: the lengthening of the operating voltage line (CCVCC line 3) and of the SIM ground line (CCGND line 4) preferably do not require any particular Requirements. However, a supporting capacitor is preferably provided (not illustrated in FIG. 1) at the card end between the CCVCC line 3 and the CCGND line 4 in order to decouple the operating voltage from the line conditions at the card end. Furthermore, the line should have as low an impedance as possible.

The CCIO line 5 is a bidirectional line which, as already mentioned, represents the data line in the arrangement. This means that both the GSM modem 2 and the SIM card 1 can transmit and receive alternately on the same line. In order to avoid damage in the event of conflicts, that is to say if the GSM modem 2 and the SIM card 1 are both connected to the output and transmit at the same time as one another, the outputs at both ends are in the form of open drains. The common drain resistor 11 which is required for this purpose is integrated in the GSM modem 2.

In order to rapidly change the charge in the capacitance of the extension line or, to be more precise, in order to assist the abovementioned change in the charge, positive edge drivers 12 and negative edge drivers 13 are coupled to the CCIO line 5 at both the modem end and at the card end, and their design and method of operation will be explained in more detail later. Once the charge on the capacitance of the CCIO line 5 has been changed, including that on its extension, neither the positive edge drivers 12 nor the negative edge drivers 13 have any effect.

The edge drivers in this case act on the respective active end, that is to say the end which is connected to the output, as a driver for the signal on the CCIO line 5, including its extension, and act as a signal regenerator at the passive end, that is to say the end which is connected to the input. The edge of the signal at the transmitting end is thus supported, that is to say the signal which is used to charge the capacitance of the line is amplified, so that the edge is kept as steep as possible; at the receiving end, the edge of the signal is additionally conditioned once again in a further amplification step.

At this point, it should be noted that there is no absolute requirement for four edge drivers, depending on the line length and the signal quality produced at the respective CCIO output 14. In this case, it is also possible to use only one positive edge driver 12 or, if the line lengths are relatively large, two positive edge drivers 12 without any negative edge driver 13 and, alternatively, a combination of positive edge drivers 12 and negative edge drivers 13.

The CCCLK line 6 is a unidirectional line from the GSM modem 2 to the SIM card 1. The clock driver stage (not illustrated in FIG. 1) which is integrated in the GSM modem 2 has a so-called push-pull output. In order to reduce the amount of the emitted radiation, the clock line is lengthened in a balanced form. An inverter 15 is provided for this purpose, which can be tuned by means of a resistor 16 to have the same internal resistance as the clock line (CCCLK line 6). Furthermore, resistors 17, 18 are provided as a line termination at the SIM card end for this purpose, and are connected to the SIM card ground CCGND 4, without any direct current, via capacitors 19, 20.

It should be noted here that if the lengths of the extension line are long, edge drivers can also be coupled to the CCCLK line 6. It should also be noted that the abovementioned method of balanced extension of the line can also be applied to other lines, such as the CCIO line 5.

The CCRST line 7 has a unidirectional signal flow from the GSM modem 2 to the SIM card 1. The driver stage, which is integrated in the GSM modem 2, has a push-pull output. It should be noted here, too, that, particularly in the case where the extension lines are long and when the driver capability of the push-pull output is poor, one or more edge drivers may be coupled to the CCRST line 7.

The position of the switching contact 9 on the card holder is signaled at the CCIN input 10. If the contact is used to run down the SIM interface, rapid transmission of the information is necessary. A driver which comprises a transistor 21 and two resistors 22, 23 is therefore provided at the card end. If the SIM card is withdrawn from the SIM card holder during operation, then, by monitoring the level at the CCIN input 10, it is possible to run down the entire SIM interface, and to switch it to a high impedance, even before the interface contacts are interrupted during the withdrawal of the SIM card.

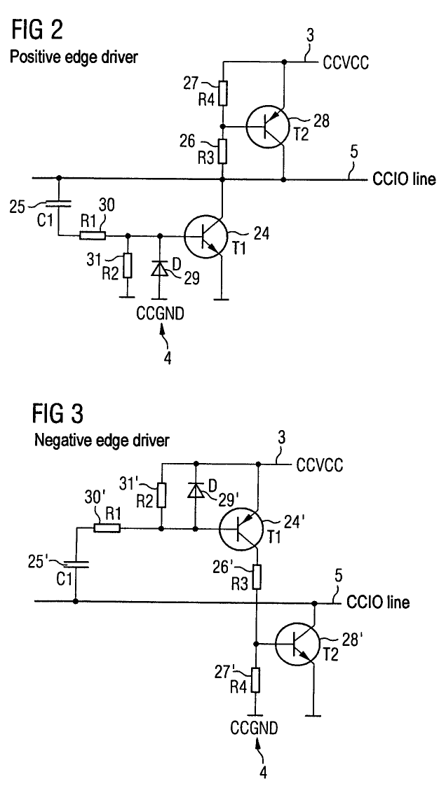

The following text describes the method of operation of a positive edge driver 12 and of a negative edge driver 13 in more detail on the basis of FIGS. 2 and 3. The edge drivers are formed from discrete components; the positive edge driver and the negative edge driver are complementary to one another, but in principle are designed identically. Their operation will be explained with reference to a positive edge driver, first of all, in the following text:

It is assumed that the signal on the CCIO line 5 is changing from the potential of the CCGND line 4 to that of the CCVCC line 3. When there is a positive change to the line level of CCIO line 5 as mentioned above, a transistor 24 is switched on as soon as its base-emitter threshold voltage (approximately 0.6V) is exceeded, with the line level of the CCIO line 5 being input via a capacitor 25.

When the transistor 24 is switched on, it switches a transistor 28 on via a voltage divider which is formed from resistors 26, 27. Via its collector, the transistor 28 raises the CCIO line 5 to the positive potential of the CCVCC line 3. This potential increase in turn acts on the base of the transistor 24, via the capacitor 25. This is therefore an amplifier arrangement with dynamic positive feedback. The described mechanism is active only for as long as the capacitor 25 is charged.

The important factor in this case is that the capacitor 25 has a capacitance such that the charge on the capacitor 25 can always be changed completely (charging and discharging) between two edges of the signal, depending on the signal frequency. The discharging of the capacitor 25 is assisted by means of a diode 29 when a negative edge occurs. Once the capacitor 25 has been charged, the entire circuit arrangement has no more effect until the next positive signal edge. This ensures that it is tolerant to steady-state signal levels and to the SIM interface being run down electrically by the GSM modem 2.

A resistor 30 is connected downstream from the capacitor 25 in order to improve the signal-to-noise ratio. In conjunction with a resistor 31, the response threshold of the transistor 24 is raised, thus increasing the signal-to-noise ratio.

The operation of the negative edge driver is explained as follows: when the potential on the CCIO line 5 changes from the potential on the CCVCC line 3 to that on the CCGND line 4, then a transistor 24′ is switched on as soon as its base-emitter threshold voltage (approximately 0.6V) is exceeded. The line level is input in an analogous manner to that for the positive edge driver 12 via a capacitor 25′. The switched-on transistor 24′ switches a transistor 28′ on via a voltage divider which is formed from resistors 26′, 25 27′, and via its collector, this transistor 28′ reduces the potential on the CCIO line 5 to the ground potential on the CCGND line 4. This reduction in turn acts on the base of the transistor 24′ via the capacitor 25′. Once again, this is an amplifier arrangement with dynamic positive feedback. The described mechanism is active only for as long as the capacitor 25′ is charged.

The design requirements relating to the capacitance of the capacitor 25′ are the same as those for the positive edge driver. The discharging of the capacitor 25′ when a positive edge occurs is assisted by a diode 29′. Once the capacitor 25′ has been charged, the entire circuit arrangement has no more effect until the next negative signal edge. Once again, the circuit arrangement is in consequence tolerant to steady-state signal levels and to electrical running down of the SIM interface by the GSM modem 2.

Analogously to the positive edge driver 12, a resistor 30′ may also be connected downstream from the capacitor 25′ in the case of the negative edge driver 13, in order to improve the signal-to-noise ratio. In conjunction with a resistor 31′, the response threshold of the transistor 24′ is in this case increased.

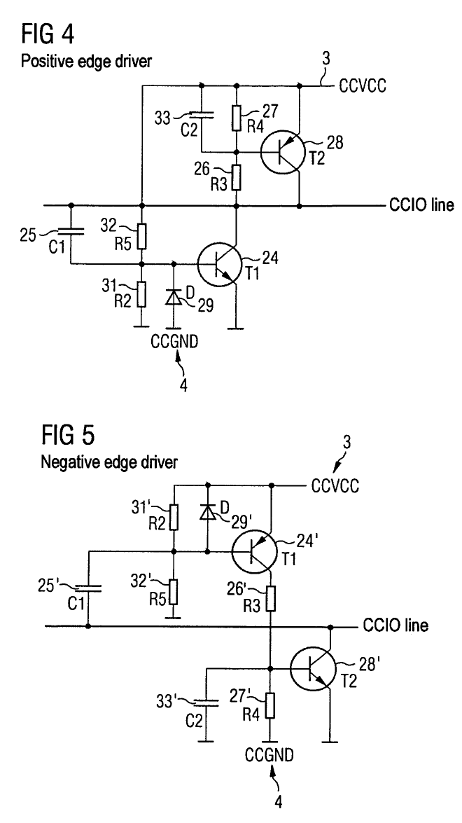

A positive edge driver 12 which has a lower response threshold rather than an improved interference separation (as shown in FIG. 2) is illustrated in FIG. 4. The corresponding negative edge driver is shown in FIG. 5. A resistor 32 which, together with the resistor 31, forms a voltage divider is connected downstream from the capacitor, instead of the resistor 30. In order to improve the response to transient interference, a capacitor 33 is also connected in parallel with the base-emitter junction of the transistor 28. This leads to a delay in the response time of the transistor 28.

Analogously to the positive edge driver shown in FIG. 4, the negative edge driver shown in FIG. 5 has a resistor 32′ and a capacitor 33′, which carry out the same function as the resistor 32 and the capacitor 33.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

1-14. (canceled)

15. An interface between a SIM card and a GSM modem comprising:
a bidirectional data line that connects a card data input/output of the SIM card to a modem data input/output of the GSM modem, wherein the data line is coupled to at least one edge driver.

16. The interface as claimed in claim 15, wherein the data line is coupled to at least one edge driver, both at the modem end and at the card end.

17. The interface as claimed in claim 15, wherein that positive and negative edge drivers are provided.

18. The interface as claimed in claim 15, wherein that only positive edge drivers are provided.

19. The interface as claimed in claim 1, wherein that the at least one edge driver is formed from discrete components.

20. The interface as claimed in claim 5, wherein that the at least one edge driver is in each case matched to different signal frequencies, in particular by the capacitance of a coupling capacitor which couples the edge drivers to the data line.

21. The interface as claimed in claim 20, wherein a resistor is connected downstream from the coupling capacitor, in order to improve the interference voltage separation.

22. The interface as claimed in claim 21, wherein the response threshold of the or each edge driver is set or tuned in by a second resistor coupled to the edge driver.

23. The interface as claimed in claim 22, wherein a second capacitor coupled to the edge driver in order to improve the response to transient interference.

24. A method for bidirectional data transmission between a SIM card and a GSM modem wherein the bidirectional data transmission takes place without the use of a control signal for the data direction on a data line that connects the SIM card and the GSM modem.

25. The method as claimed in claim 24, wherein at least one edge driver is used for conditioning of the signal on the data line.

26. The method as claimed in claim 25, wherein the at least one edge driver can in each case be optimized to the clock rate of the data transmission by inserting a coupling capacitor.

27. The method as claimed in claim 25, wherein the interference voltage separation of the at least one edge driver can in each case be set, by means of a resistor.

28. The method as claimed in claim 25, wherein the response threshold of the at least one edge driver can in each case be set or tuned, by means of a resistor.
